(19) United States
(12) Patent Application Publication
(10) Pub. No.: US 2026/0147699 A1
(43) Pub. Date: May 28, 2026

(54) RELIABILITY MANAGEMENT FOR CLOUD APPLICATIONS

(71) Applicant: Prequel Software, Inc., Rockville, MD (US)

(72) Inventors: Anthony Meehan, Rockville, MD (US); Lyndon Brown, Rockville, MD (US); Sean Cunningham, Rockville, MD (US); Robert Austin, Rockville, MD (US); Aleksandr Maus, Rockville, MD (US)

(73) Assignee: Prequel Software, Inc., Rockville, MD (US)

(21) Appl. No.: 19/402,865

(22) Filed: Nov. 26, 2025

Related U.S. Application Data
(60) Provisional application No. 63/724,961, filed on Nov. 26, 2024.

(51) Int. Cl. G06F 11/3668

(52) U.S. Cl. CPC G06F 11/3688

(57) ABSTRACT

A method for managing reliability of a cloud application includes deploying one or more detection engines into a customer environment. The method also includes monitoring data related to the reliability of the cloud application from within the customer environment. The method further includes detecting, by the one or more detection engines, a parameter affecting the reliability based on a set of rules. In addition, the method includes generating a response to interrogate the customer environment based on the parameter.

### CROSS-REFERENCE TO RELATED APPLICATION

This application claims the benefits of priority to Provisional Application No. 63/724,961, filed Nov. 26, 2024, the entire contents of which are expressly incorporated herein by reference.

### TECHNICAL FIELD

The present disclosure relates to software reliability monitoring and management, and more particularly, to systems and methods for in-cluster real-time reliability monitoring and management of cloud-based software applications.

### BACKGROUND

Identifying and troubleshooting reliability issues of cloud-based applications such as Software-as-a-Service (SaaS) applications is challenging because of the complexity introduced by factors such as their distributed architectures, dependencies, dynamic usage, and the scale of the applications. Conventional monitoring approaches rely on observability solutions that trigger noisy threshold or anomaly-based alerts in response to general symptoms like high latency or errors. With the conventional approaches, data stemmed from an in-cluster application (e.g., signals produced by code, log data, CPU usage, etc.) are transmitted to an off-cluster storage, from which customer-made queries are used to retrieve information, which is in turn fed to a variety of dashboards for display and analysis or used to trigger alerts. There are several shortcomings of these conventional approaches. First, transferring data to off-cluster storage locations can be expensive and the cost may be unpredictable. Costs include data egress fees charged by cloud services providers and data ingest and storage fees charged by observability providers. These costs are further increased when software issues arise, and more errors and metrics are logged. The amount of data flowing out to off-cluster storages can increase dramatically. Second, interpreting data based on dashboards and high-level alerts requires complex manual analysis and expert knowledge to understand issues and identify underlying issues. Third, customer defined rules may not be optimal and efficient nor provide appropriate actionable mitigation steps for underlying issues.

Methods, systems, and computer readable media disclosed in this application aim to mitigate the above-mentioned shortcomings with in-cluster real-time monitoring and management technologies.

### SUMMARY

In some embodiments, a method is provided for managing reliability of a cloud application. The method may include deploying one or more detection engines into a customer environment. The method may also include monitoring data related to the reliability of the cloud application from within the customer environment. The method may further include detecting, by the one or more detection engines, a parameter affecting the reliability based on a set of rules. In addition, the method may include generating a response to interrogate the customer environment based on the parameter.

In some embodiments, a system is provided for managing reliability of a cloud application. The system may include a memory coupled with one or more processors and computer readable instructions stored in the memory that, when executed by the one or more processors, cause the one or more processors to perform operations. The operations may include deploying one or more detection engines into a customer environment. The operations may also include monitoring data related to the reliability of the cloud application from within the customer environment. The operations may further include detecting, by the one or more detection engines, a parameter affecting the reliability based on a set of rules. In addition, the operations may include generating a response to interrogate the customer environment based on the parameter.

In some embodiments, a computer readable medium is provided that stores instructions that, when executed by one or more processors, cause the one or more processors to perform operations. The operations may include deploying one or more detection engines into a customer environment. The operations may also include monitoring data related to the reliability of the cloud application from within the customer environment. The operations may further include detecting, by the one or more detection engines, a parameter affecting the reliability based on a set of rules. In addition, the operations may include generating a response to interrogate the customer environment based on the parameter.

### BRIEF DESCRIPTION OF THE DRAWINGS

FIG. 1 shows an architecture of an exemplary reliability management platform, according to embodiments of the present application.

FIGS. 2A and 2B shows exemplary detection engines and visualize sequence, according to embodiments of the present application.

FIG. 3 shows an exemplary graph use case, according to embodiments of the present application.

FIG. 4 shows an exemplary visualization sequence, according to some embodiments of the present application.

FIG. 5 shows a real-world scenario observed with some embodiments of the present application.

FIG. 6 shows an exemplary computer system configured to implement various functions of the present application.

### DETAILED DESCRIPTION

Embodiments of the present application provide a problem detection and management platform for cloud applications using deterministic detections to precisely flag underlying failure conditions from the bottom up in production, staging, or development environments. Each identified problem can be mapped to current impact with clear mitigation steps.

The backbone of the disclosed technologies includes multi-tiered in-cluster real-time detection engines purposefully built to detect problems described by reliability intelligence. The detection engines are capable of efficiently running thousands of real-time detections per second against a continuous and asynchronous stream of low-level telemetry and operating system events, without raw data leaving a customer's cluster. This is in stark contrast to observability solutions that rely on collecting, moving, and storing gigabytes of costly telemetry, 90% of which is never used.

The disclosed platform can serve as a first line of defense improving the reliability of high-availability applications, with example use cases spanning fintech, infrastructure, and SaaS. The platform can proactively take on tedious problem detection and analysis tasks, enabling site reliability engineers (SREs) and software engineers to shift valuable time from firefighting to feature development and futureproofing.

In some embodiments, customers can deploy the platform by running a single command. Once installed, the platform can automatically instrument workloads and begin running a dynamic set of complex problem signatures in real-time against traces, metrics, logs, Kubernetes events, container runtime events, process events, CPU, memory profiles, and the like.

Compared with conventional approaches, technologies disclosed herein utilize one or more in-cluster detection engines that reduce data egress and enable richer real-time analysis. In addition, rather than relying on customer defined rules, a novel method is provided to capture and describe global reliability intelligence in the form of machine-readable detection rules that detect reliability problems. These detection rules can be sourced from inventors, customers, and community contributors and disseminated to the aforementioned detection engines in real-time. Further, the disclosed technologies can be conveniently deployed to existing systems, requiring no additional instrumentation, no further data integration, and no complex configuration.

In this application, certain terms are used to describe software reliability management methods and systems. Below is an inexhaustive list of terms and concepts with their definitions and/or examples.

“Traces” include customer generated trace data from protocols, such as HTTP, GRPC, Postgres, Katka, Redis, etc.

“Logs” include computer generated logs and Kubernetes events.

“Metrics” include application-specific stats, protocol metadata (e.g., latency), process metadata (e.g., CPU and memory usage), etc.

“CPU Profiles” include application call stack traces with observation counts over a period of time.

“Data” include traces, logs, metrics, and CPU profiles.

“Detection” includes notifications generated when rules are triggered and can contain severity and investigation details. Exemplary detections include High HTTP Latency, OOM Crash, N+1 Database Query, CRE-2023-001 Known Kafka Performance Issue, etc.

“Analytic” includes automated response actions used to interrogate a customer environment. Exemplary analytics include Heap and CPU profilers like py-spy, async-profiler, heaptrack, etc.

“Service Graph” refers to certain representations disclosed herein of processes, services, containers, pods, nodes, clusters, and their relationships in a data structure that the disclosed systems analyze, visualize, and modify.

Embodiments of the present application can collect data from a variety of sources, including Kubernetes event logs (e.g., via the Kubernetes API), container logs (e.g., via the container runtime), process metrics, traces (e.g., via ebpf), HTTP/GRPC traces, DNS traces, Redis traces, Postgres traces, Kafka traces, RabbitMQ traces, MongoDB traces, etc.

In some embodiments, a command line interface (CLI) can be provided to monitor the health of software deployments and hunt for application reliability problems. Cluster components can respond to health messages input to the CLI and report CPU, memory, disk, and other usage statistics.

In some embodiments, policies can be used to decide what detection rules to apply to what clusters and nodes. Cluster policies can be updated with configmap changes in the backend. Rules can be updated when new rule packages are published.

In some embodiments, KPIs are visible to end users to indicate the total number of rules that are enabled for their platform. The current version of the rules installed in their platform can also be visible to the end users. For each rule, the following elements can be visible to end users:
Title
Category Name
Category Description
Last Seen Detection
Tag Names
Tag Descriptions
Number of Detections
A link to the most recent detection
Whether that rule is enabled
Severity
A description
Triage and mitigation instructions

In some embodiments, rule packages can be compiled and uploaded to the reliability management platform. Rule package changes can be automatically reflected in the user interface (UI).

In some embodiments, cluster components can download and install new rule package updates when their policies are updated.

One or more rule elements can be sorted, including, for example, title, severity, category display name, last seen timestamp, and detection count.

One or more rule elements can be filtered, including, for example, title, severity, category, and tag display name. The filtering can support operators such as “==”, “!=”, “>”, “>=”, “<”, “<=”, and “like.”

Detections can be generated when a rule matches on one or more conditions in a customer deployment. A new detection in the Detection List page can be visible to a user without refreshing the page. New detections can be shown in bold to indicate they are unread.

For each detection, the following elements can be visible to end users:
First seen timestamp
Cluster name (cluster ID if there is no name)
Workload name
Container name
Rule title for the detection
Category name and description
Severity
Last seen timestamp (or the First Seen timestamp if no duplicate detections have occurred)
Duration of the detection (or showing “--” if no duplicate detections have occurred)
Action—View Details

KPIs that indicate the total number of detections, the counts of detections over time over a period of time (e.g., last week), and top 3, 4, or the like detections by category over the period of time can be visible to end users.

One or more detection elements can be sorted, including, for example: first seen timestamp, cluster name, namespace, workload (K8s object), container name, detection title, category display name, severity, last seen timestamp, duration.

One or more detection elements can be filtered, including, for example, namespace, cluster name, workloads, container and pod names, detection title (like), category display name, severity. The filtering can support operators such as “==”, “!=”, “>”, “>=”, “<”, “<=”, and “like.”

When a detection fires, the following detection elements may be provided or displayed to a user for each detection: summary, filters, timeline of events, timeseries charts, detection details data.

In some embodiments, the disclosed reliability management platform can run on clusters with up to 50 nodes with no more than 5% CPU and 1 GB memory in probes and no more than 5% CPU and 250 GB memory in the collector.

In some embodiments, the disclosed reliability management platform can synthesize global failure knowledge and turn this knowledge into problem detection rules. The data, known as reliability intelligence, is distributed to clients in real-time, to power one or more in-cluster detection engines. Each rule may include a detailed description of the problem and a set of remediation recommendations. Rules can combine one or more event types and apply complex logic across synchronous events. Rule logic can be stacked, preserving state with a time window. A context window over time is used by the detection engine to detect asynchronous and out-of-order events across a multitude of data sources in real time without any data leaving a customer environment.

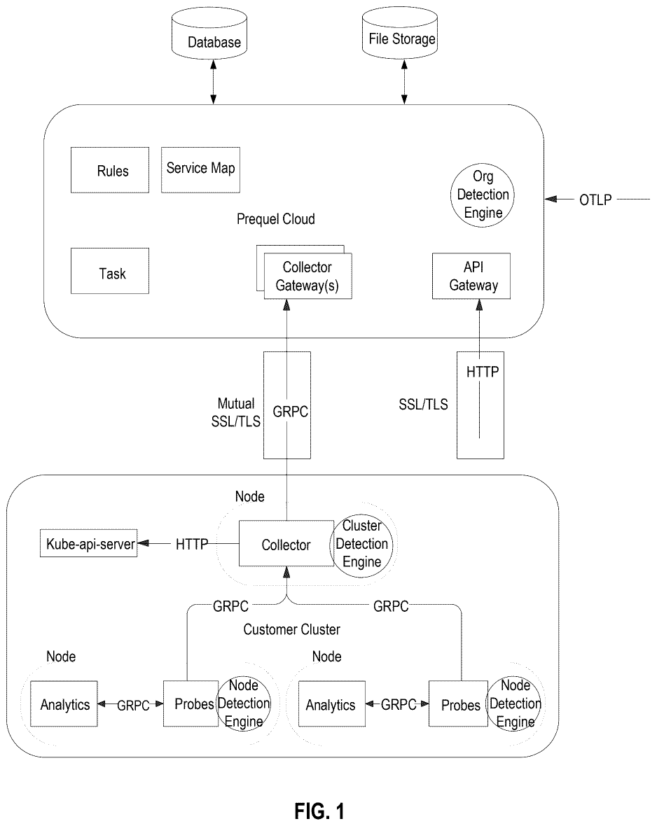

FIG. 1 shows an architecture of an exemplary reliability management platform, according to embodiments of the present application. As shown in FIG. 1, the reliability management platform may include a Node Detection Engine, a Cluster Detection Engine, and an Organization Detection Engine.

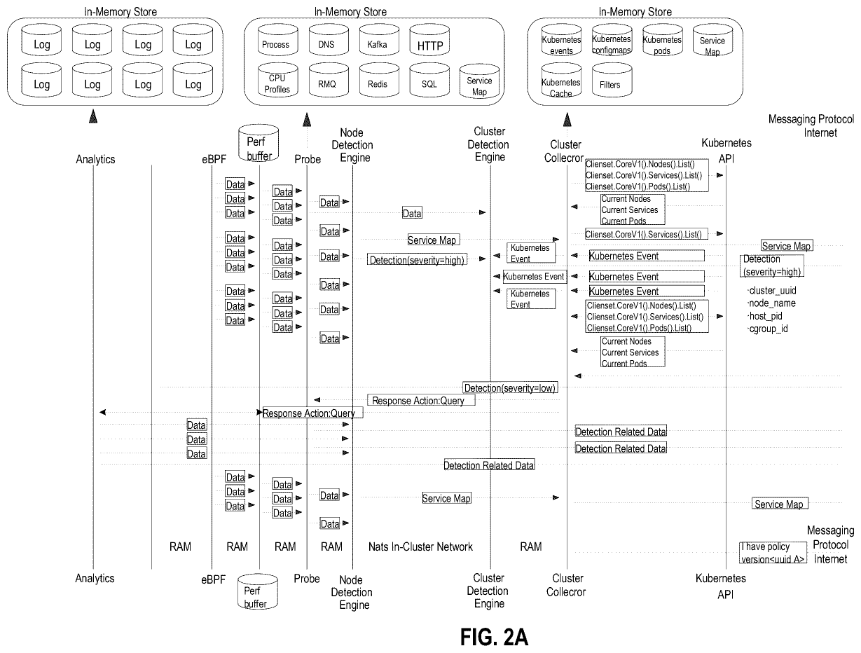

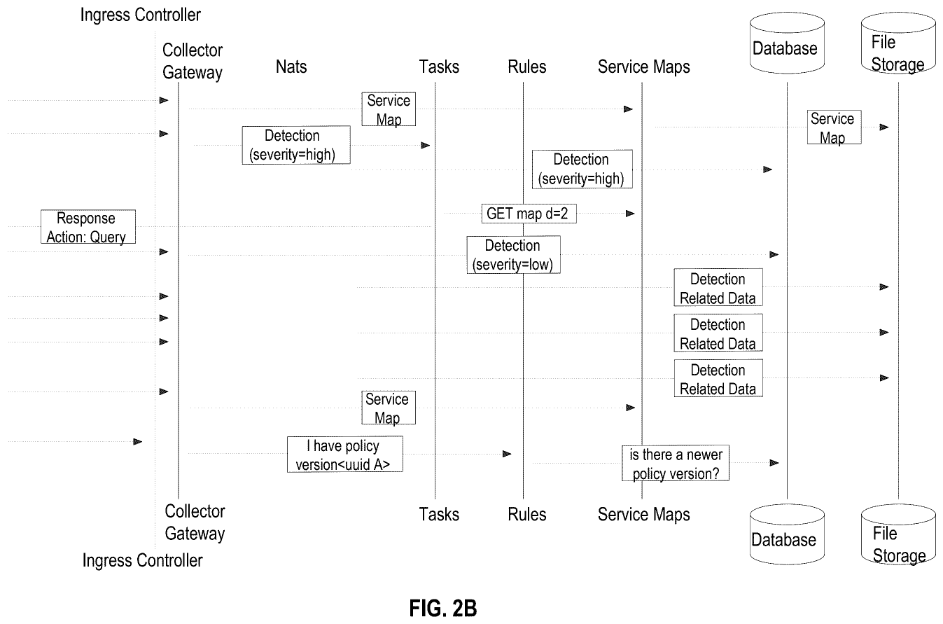

FIGS. 2A and 2B together show a sequence diagram and exemplary interactions between the embodiments of the present application.

The Node Detection Engine may run on every node. The Node Detection Engine may be responsible for receiving data from a Probe and detecting issues with process metadata, CPU profiles, protocol data, container runtime events, process events, and Kubernetes event data. The Node Detection Engine may generate detections using rules on these data. In some embodiments, detections that leverage log line patterns (e.g., regex) can be supported.

The Cluster Detection Engine may run on one node. The Cluster Detection Engine may be responsible for receiving a subset of data from Probes as well as low severity detections. The Cluster Detection Engine may generate detections using rules on these data.

The Organization Detection Engine may receive data from OpenTelemetry-instrumented clusters and data from one or more detection engines described above.

An exemplary sequence of utilizing one or more detection engines to perform detection tasks is as follows.
1. Node eBPF probes sends data to the Probe via perf buffers in RAM.
2. This data is forked to a persistent store and to the Node Detection Engine (a subset of the data that is only needed for detections).
3. Some data from the Probe is sent to the Cluster Collector. This data may contain process metrics and metadata to help route requests from the platform backend. It is cached in RAM.
4. The Node Detection Engine detects a problem. The severity is HIGH. It forwards a detection to the Cluster Collector.
5. The Cluster Collector forwards the detection to the platform backend.
6. The Collector Gateway routes the message to the appropriate services, for example, using Nats.
7. A Tasks service receives the detection. Because the severity is HIGH, automated troubleshooting analytics may be run on adjacent services to detect additional problems along a chain of related services. Host+PID/cgroup level resolution may be needed to do this to obtain additional relevant events for detections. In the event that this resolution is unavailable, some helpful context may be used to narrow a search in the Cluster Collector (e.g., a list of known destination IP addresses or containers that are adjacent to the origin process that experienced the HIGH detection). In a single customer use case spanning multiple clusters, this would be the right place to determine where to route follow-on automated actions to clusters.
9. The Tasks service sends a Query Response Action to the Collector. This query asks the Cluster Collector to collect relevant logs, Kubernetes data, protocol traces, etc. for the adjacent services.
10. The Cluster Collector may need PID/cgroup+host level resolution and may need knowledge of the protocol data type, the source port of the originating process in the initial HIGH detection (and ideally external source IP address), the destination addresses and ports of known adjacent services, and a time box window (e.g., 60 s). Using this information, the Cluster Collector can query all nodes for data matching the criteria and obtain PIDs, cgroups, and hosts. Then the Cluster Collector can take automated actions (e.g., collect logs, profile, etc.).
11. The Cluster Collector sends automated actions for the resolved PIDs and hosts.
12. Meanwhile, another detection occurs at the Logs Detection Engine for an exception in the logs. This detection severity is LOW.
13. The Cluster Collector forwards this detection to the Cluster Detection Engine and the platform backend.
14. The Collector Gateway records this detection event in Postgres.
15. Data is returned from the automated query in 11. It is proxied by the Cluster Collector.

Embodiments of the present application can utilize a service graph (or “graph” for simplicity) to represent processes, services, containers, pods, nodes, clusters, and their relationships. In some embodiments, a graph can be constructed using Kubernetes state and service map data to visualize a relational map of the processes/pods/services in a customer cluster (referred to as a “visualization”). Kubernetes state and service map data can also be used to automatically determine which processes are connected/dependent to another process involved in a detection (referred to as a “directed PID/group-graph”).

The following are several exemplary scenarios related to visualization and directed PID-graphs.
1. source pid:container:pod:service=1:1:1:1

In this scenario, a corresponding container is successfully found in Kubernetes for the given host process cgroup identifier from/proc. With a valid container, a corresponding pod can be found. With the knowledge of the pod and its corresponding set of labels (1 or more string key/value pairs), all known services can be iterated over to find only one matching service where all selectors (1 or more string key/value pairs) exist in the set of pod labels.
2. source pid:container:pod:service=1:1:1:many

This is a similar scenario to #1 except more than one service are found where every selector happens to exist in the pod's set of labels.
3. source pid:container:pod:service=1:1:1:none

Here no pod can be found that contains all selectors for any service. It is likely that this pod is only a deployment and there is no service.
4. destination address:pod:service=1:1:1

For destinations an IP address and a port number are known. The IP address can be used to iterate through all known pod and service IP addresses. In this scenario, a corresponding match can be found for a pod IP address. The same pod->service algorithm above can then be employed to find only one matching service.
5. destination address:pod:service=1:1:many

In this scenario, a match on the IP address for a pod is found but, like #2 above, multiple services that select this pod are found.
6. destination address:pod:service=1:1:none

In this scenario, a match on a pod is found but, like #3 above, there is no service that selects this pod.
7. destination address:pod:service=1:none:none

Here, no pod or service that matches on this IP address can be found. It's likely that this IP address exists outside the cluster.
8. destination address:service

In this example, a match on a service is found but not a pod. The connection is proxied through a service to a corresponding set of pod replicas (1 of n possible pods where n=1 or n=10,000).

For the visualization use case, a useful visual map for each of the scenarios above can be created. These visual maps can be used to resolve and present the Kubernetes state.

For the directed PID/cgroup-graph use case, at least container-level (cgroup) resolution is needed for all nodes. It is preferable to achieve PID/cgroup+host level resolution for all nodes. This is because some automated action like collecting logs or profiling a process may be conducted. There are three challenges here when identifying one or more PID/cgroup+host tuples to perform some automated action in the directed PID/cgroup-graph use case.

1. Determine which Pid in a Container

In many scenarios above it will be possible to derive the destination container. This will provide a cgroup identifier. However, there can be more than one relevant process in that cgroup namespace. For example, Python's gunicorn will start several worker processes that accept connections from the main server. These worker processes are regularly restarted. When an issue somewhere else in the architecture is detected and it is determined that the destination is a container like this, it should be determined which specific process ID in this container to target. For the case of collecting logs, all of the stdout logging for each process should go to the same container-level log file. But for other cases of interrogating a specific process ID automatically, PID level resolution may be needed.

2. Determine which Container in a Pod

Similar to challenge #1, the destination container may not be able to be derived if a pod has more than one container. This can add a layer of complexity to obtain pid+host level resolution.

3. Determine which Pod in a Service

Similar to challenge #1 and #2, the destination pod may not be able to be derived if the source process is making a connection to a service IP address (see scenario #8 above).

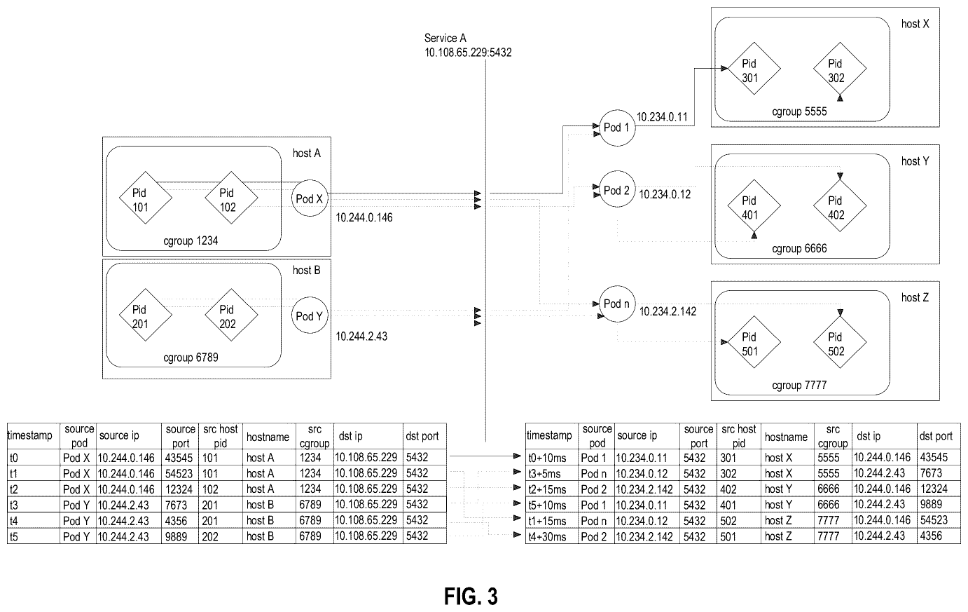

FIG. 3 shows an exemplary graph use case, according to embodiments of the present application.

As shown in FIG. 3, several pods on the left make connections to a service. These connections are routed to one of many pods associated with Service A. Kubernetes has multiple ways of implementing service map routing. One common way is with iptables. Other methods may use service meshes, like Linkerd or Istio.

The tables at the bottom represent the protocol data for most TCP protocols. There are a few exceptions, like GRPC, where visibility into GRPC data is available with languages such as C/C++, Go, and Rust.

One approach to the visualization use case is to extract relationships from protocol trace data but only collect and cache new relationships so that a vast majority (e.g., 99%) of the protocol data can be ignored. This approach works well for visualizations to represent a relationship. Relationships can be aged off so that stale connections disappear. A combination of data volume and connection counts can be used to indicate affinity or the significance of a relationship. With Kubernetes data, pod-level resolution is available for all nodes in a cluster (not for any IPs outside the cluster).

For the directed PID-graph use case, however, the above-described approach may not work. What is needed is pid and host level resolution for nodes. To resolve an IP address and destination port to the correct process ID and hostname, the timeseries protocol trace data during a small window of time needs to be queried. One approach to make the connection would be to report the source port for the source node and look up the source pod IP address in the Kubernetes state. Using this information, the destination-side protocol trace data can be searched to find a corresponding entry to the destination port from the reported source port and source IP address. A map can be shown from the cache and eventually the specific connection can be shown as overlayed on top of the map once the result from the asynchronous query is received.

Here's an example of what the same connection looks like from both the source and destination:

$$\begin{matrix}[ http ] tns = 1705983504474326137 pid = 16033669 hst = minikube - m 02 \\ rad = 10.244 \text{.2} \text{.200} pth = / mth = GET lns = 824355 \\ [ http ] tns = 1705983504474883048 pid = 1250582 hst = minikube = m 03 \\ rad = 10.109 \text{.127} \text{.197} pth = / mth = GET lns = 1142342\end{matrix}$$

10.109.127.197 is the service IP address on minikube-m03.
10.244.2.200 is the client making the HTTP connection from minikube-m02.

The difference in time is 0.56 ms (560128 ns).

Some key questions are as follows:
How to obtain PID/cgroup+host level resolution for the directed PID/cgroup-graph use case?Can the proposal above be used?
When attempting to resolve a destination IP address to a process ID and host, under what circumstances would leveraging the source port of the source origin node over a small window (e.g., 5 ms) not be enough?

If the source port method doesn't work, one could investigate a similar approach with SEQ/ACK numbers. One can also investigate hooking NAT-routing kernel functions to record some data in RAM that can help with lookups.
How would this work for long-duration asynchronous relationships where the amount of time is large that could have passed (on the order of seconds or minutes) before or after the initial problem was detected?

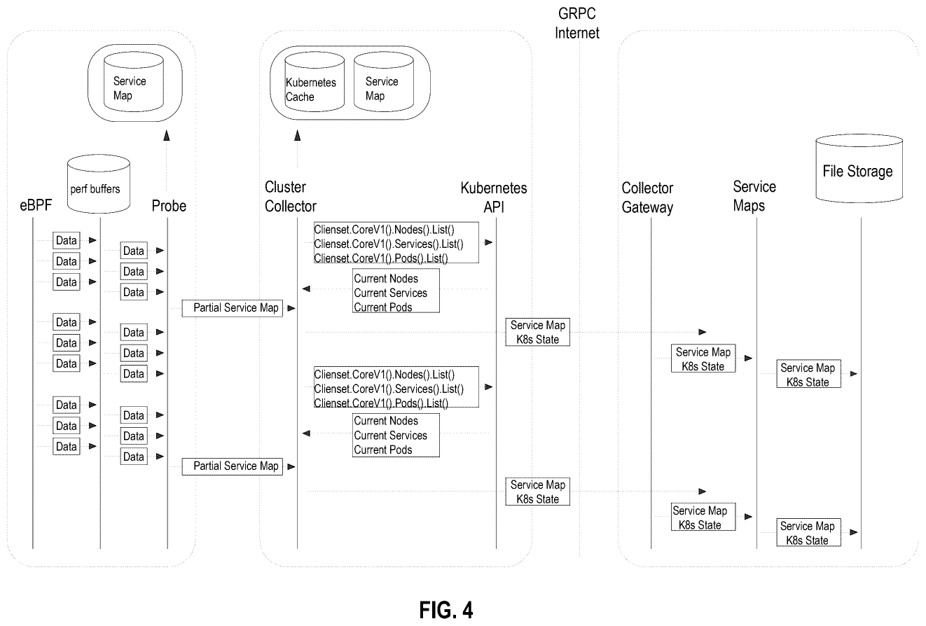

FIG. 4 shows an exemplary visualization sequence, according to some embodiments of the present application.

As shown in FIG. 4, the Probe receives trace data from the node operating system about the customers environment. This data comes from two sources: 1) eBPF probes write data to shared memory (perf buffers) that the Probe reads, or 2) continuous surveys of the/proc filesystem.

The Cluster Collector orchestrates communications and configurations across a customer cluster of nodes running services.

The Collector Gateway receives and routes messages from Cluster Collectors installed on customer clusters.

The Service Maps service processes service maps (timestamp, hostname, host process id, process start date, process path, etc.) and Kubernetes state information (nodes, services, pods, endpoints, etc.).

Given the context above, the following passages describe how to collect relationships and Kubernetes state for both the visualization use case and the directed PID-graph use case.

### Visualization Sequence

1. The Cluster Collector uses the KUBERNETES_SERVICE_HOST environment variable to authenticate to the Kubernetes API.
2. On a regular interval (default 60 s), the Cluster Collector lists the following Kubernetes resources: nodes, services, pods, containers. This data is stored in a cache in the Collector.
3. The Probe receives data (e.g. protocol traces, CPU profiles, process metrics).
4. The Probe does not derive relationships from protocol trace data. It instead sends new raw relationships (examples below that reference the NAT routing diagram above) to the Cluster Collector where it is cached (with an age off period).
5. The Cluster Collector forwards new relationships to the platform backend along with the most recent Kubernetes state for nodes, services, pods, etc.

This should provide enough data to create a map. For customers using Kubernetes data, the map should be resolved to the service level first (since a service may be composed of thousands of pods) and pod level when a service does not exist.

Example source-side raw relationship data of a connection:

```
{
  “timestamp”: <t3>,
  “source”: {
    “host_pid”: 201,
    “cgroup”: 6789,
    “hostname”: “B”,
    “port”: 7673
  },
  “destination”: {
    “address”: “10.108.65.229”,
    “port”: 5432
  },
  ″magnitude″: {
    ″bytes″: 43545
  }
}
```

Example destination-side raw relationship data of the same connection:

```
{
  “timestamp”: <t3+0.5ms>,
  “source”: {
    “host_pid”: 302,
    “cgroup”: 5555,
    “hostname”: “X”,
    “port”: 5432
  },
  “destination” : {
    “address”: “10.244.2.43”,
    “port”: 7673
  },
  ″magnitude″: {
    ″bytes″: 43545
  }
}
```

The disclosed platform can provide information about when there is high latency and when a process restarts unexpectedly (e.g., Kubernetes).

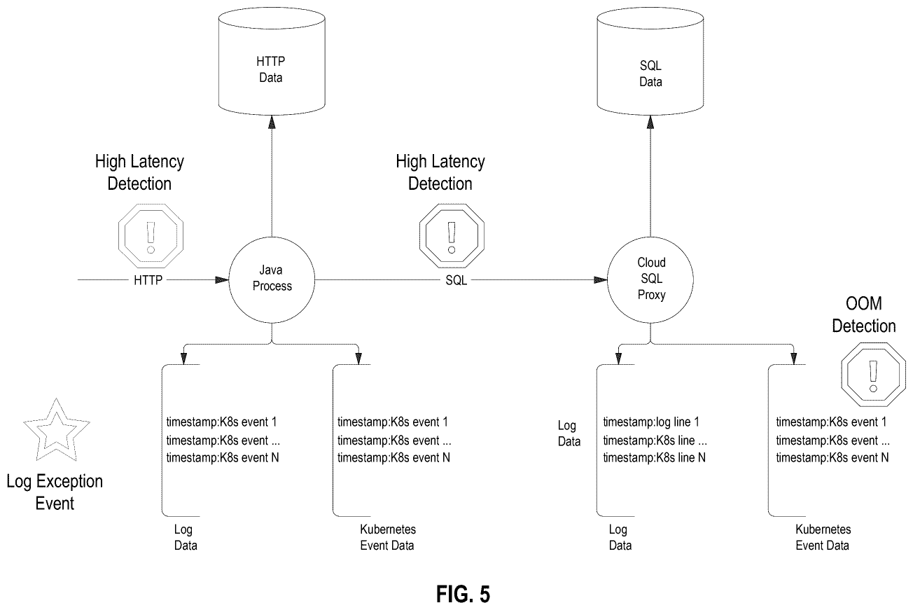

FIG. 5 shows a real-world scenario observed with some embodiments of the present application.

As shown in FIG. 5, the platform can detect that HTTP requests to an API method for a Java process is experiencing high latency at time T1. This could be a moving average threshold over 400 ms (doherty threshold) is exceeded during a 60 second window.

The platform can detect that SQL queries to another process (Google cloud sql proxy) are slow around T1.

The platform can detect that the cloud sql proxy process crashed/restarted with an OOMKilling event in Kubernetes around T1.

The platform can provide observation of an exception in the logs for the Java process around T1.

Instead of relying on querying off-cluster data transmitted from an in-cluster cloud application to monitor the reliability of the cloud application, embodiments of the present application provide a platform that deploys in-cluster monitoring applications such as one or more detection engines and/or rule engines to capture real-time reliability related data including traces, logs, metrics, CPU/memory profiles, etc. In this way, the data is retained onsite at the customer system and need not be transmitted offsite to remote or third-party storage systems. The in-cluster detection engines and/or rule engines form an expert system capable of detecting more relevant data (e.g., process starting and ending data) than conventional observability approaches, can detect using asynchronized data, and can detect in real time as data are generated. Further, snapshots can be implemented to save relevant data for evaluation and verification purposes.

Embodiments of the present application integrate an expert system with a Rete network to enhance the performance of rule-based reasoning. Telemetry and other events are facts asserted into working memory, while rules are compiled into a Rete network. The network includes a series of nodes that perform incremental evaluations of patterns to detect problems described by reliability intelligence based on whether certain conditions described by the rule are true or false. Changes to facts are propagated through the network, ensuring that only affected nodes are re-evaluated. This selective processing minimizes computational overhead.

Moreover, embodiments of the present application can dynamically modify and update rules based on knowledge from third party repositories as well as peer customers. The new or updated rules can be pushed to in-cluster deployment without recompiling the application code. Rule updates can be based on captured knowledge from third party sources such as github, inter organization knowledge base, internal research, and/or customer base. Intelligence gain from these sources can be used for early detection and adaptive rule updating.

Some embodiments can save snapshots when a detection event occurs to store certain pieces of signals for a relatively short period of time. The snapshot data may not leave the in-cluster customer environment. Instead, snapshots may be stored in-cluster or onsite the customer environment.

Some embodiments may use file descriptors to query log files as new lines are written into the log files. This would be more efficient than generating, transmitting, and querying copies of log files stored in off-cluster storage.

Some embodiments may deploy detection engines in a distributed manner such that detection engines can run on each node and/or on different levels. Such a configuration enables cascading detection in which lower-level detection engines escalate information to upper-level detection engines for more efficient detection. Enrichment of the data can also be implemented to allow for, for example, rules for different data sources.

Some embodiments may generate graphs to provide enhanced insights about the relationships among data. For example, this can be implemented using the container concept coming from Linux cgroups. An exemplary connection resolution approach can be implemented as follows: the platform can monitor TCP connections of all processes and use process ID and cgroup ID to build a graph of a cluster where each node is the process ID and cgroup ID and each edge is a connection (a TCP connection, an HTTP connection, etc.). With the cgroup ID and process ID, knowledge about connection is preserved and can be used to track data flowing within the customer environment. For example, the graph can provide insights about neighbors, which can reveal interconnection relationships between processes, which can be used for detection of software failure or reliability issues. In addition, process ID and cgroup ID can also be used to find information in the log files to obtain in-depth information about performance and/or reliability issues.

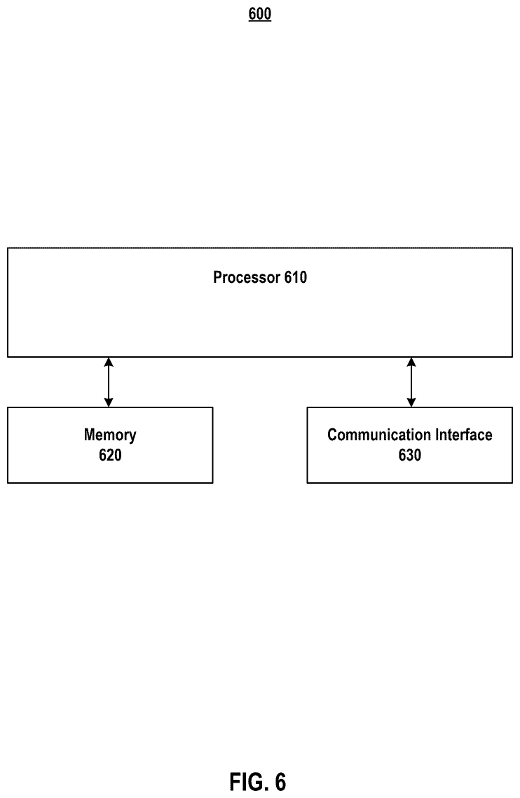

The various functionality discussed in the present application may be implemented by a computer system 600 shown in FIG. 6. As shown in FIG. 6, computer system 600 may include a processor 610, a memory 620, and a communication interface 630. Processor 610 may be in the form of any processing units such as CPU, GPU, microprocessor, etc. Memory 620 may be in the form of any volatile or non-volatile memory device such as RAM, ROM, flash drive, hard disk drive, etc. Memory 620 may store computer readable instructions that can be executed by processor 610 to perform operations for implementing the various functions disclosed in the present application. Communication interface 630 may include any form of information exchange devices such as network adaptor, bus, fiber optical adaptor, etc. Processor 610 may communicate with other devices by transmitting and/or receiving information through communication interface 630.

A further aspect of the disclosure is directed to a non-transitory computer-readable medium storing instructions which, when executed, cause one or more processors to perform the methods disclosed herein. The computer-readable medium may be volatile or non-volatile, magnetic, semiconductor-based, tape-based, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

1. A method for managing reliability of a cloud application, comprising:
deploying one or more detection engines into a customer environment;
monitoring data related to the reliability of the cloud application from within the customer environment;
detecting, by the one or more detection engines, a parameter affecting the reliability based on a set of rules; and
generating a response to interrogate the customer environment based on the parameter.

2. The method of claim 1, further comprising:
monitoring connections of processes within the customer environment, wherein each of the processes comprises a process ID and a cgroup ID and each of the connections comprises a connection type; and
generating a graph based on the connections of processes, wherein the graph comprises nodes and edges connecting the nodes, each node indicating the process ID and the cgroup ID of a process and each edge indicating the connection type of a connection between two processes.

3. The method of claim 1, further comprising:
generating a snapshot in response to the detection of the parameter, wherein the snapshot comprises signals within the customer environment within a short period of time before or after detecting the parameter.

4. The method of claim 1, further comprising:
obtaining intelligence used to determine the reliability of the cloud application, pinpoint causes, or determine mitigations, from one or more sources; and
updating the set of rules based on the intelligence.

5. The method of claim 4, wherein the one or more sources comprise a third-party repository.

6. The method of claim 4, wherein the one or more sources comprise information obtained from other customer environments.

7. A system for managing reliability of a cloud application, comprising:
a memory coupled with one or more processors; and
computer readable instructions stored in the memory that, when executed by the one or more processors, cause the one or more processors to perform operations comprising:
deploying one or more detection engines into a customer environment;
monitoring data related to the reliability of the cloud application from within the customer environment;
detecting, by the one or more detection engines, a parameter affecting the reliability based on a set of rules; and
generating a response to interrogate the customer environment based on the parameter.

8. The system of claim 7, wherein the operations further comprise:
monitoring connections of processes within the customer environment, wherein each of the processes comprises a process ID and a cgroup ID and each of the connections comprises a connection type; and
generating a graph based on the connections of processes, wherein the graph comprises nodes and edges connecting the nodes, each node indicating the process ID and the cgroup ID of a process and each edge indicating the connection type of a connection between two processes.

9. The system of claim 7, wherein the operations further comprise:
generating a snapshot in response to the detection of the parameter, wherein the snapshot comprises signals within the customer environment within a short period of time before or after detecting the parameter.

10. The system of claim 7, wherein the operations further comprise:
obtaining intelligence used to determine the reliability of the cloud application, pinpoint causes, or determine mitigations, from one or more sources; and
updating the set of rules based on the intelligence.

11. The system of claim 10, wherein the one or more sources comprise a third-party repository.

12. The system of claim 10, wherein the one or more sources comprise information obtained from other customer environments.

13. A computer readable medium storing instructions that, when executed by one or more processors, cause the one or more processors to perform operations comprising:
deploying one or more detection engines into a customer environment;
monitoring data related to the reliability of the cloud application from within the customer environment;
detecting, by the one or more detection engines, a parameter affecting the reliability based on a set of rules; and
generating a response to interrogate the customer environment based on the parameter.

14. The computer readable medium of claim 13, wherein the operations further comprise:
monitoring connections of processes within the customer environment, wherein each of the processes comprises a process ID and a cgroup ID and each of the connections comprises a connection type; and
generating a graph based on the connections of processes, wherein the graph comprises nodes and edges connecting the nodes, each node indicating the process ID and the cgroup ID of a process and each edge indicating the connection type of a connection between two processes.

15. The computer readable medium of claim 13, wherein the operations further comprise:
generating a snapshot in response to the detection of the parameter, wherein the snapshot comprises signals within the customer environment within a short period of time before or after detecting the parameter.

16. The computer readable medium of claim 13, wherein the operations further comprise:
obtaining intelligence used to determine the reliability of the cloud application, pinpoint causes, or determine mitigations, from one or more sources; and
updating the set of rules based on the intelligence.

17. The computer readable medium of claim 16, wherein the one or more sources comprise a third-party repository.

18. The computer readable medium of claim 16, wherein the one or more sources comprise information obtained from other customer environments.
